(19) United States
(12) Patent Application Publication
(10) Pub. No.: US 2014/0277897 A1
(43) Pub. Date: Sep. 18, 2014

(54) System for Automatic Driving and For Warning of Areas of Reduced Speed for Vehicles

(71) Applicant: Manuel M. Saiz, Almeria (ES)

(72) Inventor: Manuel M. Saiz, Almeria (ES)

(21) Appl. No.: 14/343,421

(22) PCT Filed: Aug. 30, 2012
(86) PCT No.: PCT/ES2012/000236

§ 371 Date: Apr. 24, 2014

(30) Foreign Application Priority Data
Sep. 7, 2011 (ES) P201101025

(51) Int. Cl. B60W 30/12; G05D 1/02

(52) U.S. Cl. CPC B60W 30/12; G05D 1/021
USPC 701/23

(57) ABSTRACT

The system for automatic driving and for warning of areas of reduced speed for vehicles which consists of placing in the lower area of the vehicle a signal detector and sensor system using reflective encoded elements, strips or bands arranged on the road surface or underground in the same. The signals received when are transverse or inclined are applied to a microprocessor, or directly to a visual warning or to an audio annunciator. The microprocessor decodes and compares the signals obtained with the vehicle speed, calculating and providing audible and visual warning signals. Additionally the system can provide lateral displacement signals with reference to central longitudinal lines, bands or strips, lateral or close to said side area, captured by the sensors in the bottom of the vehicle, and/or place a video camera or a laser radar in the upper front of the vehicle, for an automatic guided of the vehicle.

### INDEX TO RELATED APPLICATIONS

This application claims the benefit of PCT application PCT/ES2012/000236, filed Aug. 30, 2012, which claims the benefit of Spanish patent application number P201101025 filed Sep. 7, 2011, the disclosure of which is incorporated herein by reference in their entirety.

### FIELD OF THE INVENTION

In restricted speed warning systems and automatic driving for vehicles including toys.

### STATE OF THE ART

Currently, in the places you want to reduce the speed of vehicles are placed small roundabouts, recesses, loins or shoulders, pillows, mattresses, plateaus, hammers, separating islands, occasional narrowing, T-junction modifications, and zigzag paths, all of which are expensive, uncomfortable and can be dangerous. The signalize is expensive and thus scarce or inadequate and in some cases, as in the cities, it is not displayed correctly due to distraction and the large number of signals, vehicles, people or moving objects. Moreover patents U.S. Pat. No. 7,415,134, U.S. Pat. No. 7,034,861, U.S. Pat. No. 7,006,667, U.S. Pat. No. 6,091,833 and U.S. Pat. No. 5,359,666 claiming automatic guided vehicles driving or using a front camera which captures and provides a front view of the road, requiring the reference of the two sidelines of each route and does not provide advance notice of dangerous speeds. The present invention solves these drawbacks.

### OBJECT OF THE INVENTION

Use an audio or light warning system in the vehicle, simple, useful, economical, effective and safer than current signals. The signals are recorded and then interpreted by a microprocessor in the vehicle, generating the corresponding warning signals.

Use a driving or automatic guided system, simple, useful, economical and safe using a longitudinal centre line on the pavement.

Use different coded transverse lines, which are compatible with existing visual signals and can replace or delete them. In addition, due to its low cost and simplicity permit add signs in places where it is not currently practical or economical its use.

Provide a system that due to its higher reliability and safety can prevent many accidents.

### DESCRIPTION OF THE INVENTION

The system for automatic driving and for warning of areas of reduced speed for vehicles of the invention of the type used in vehicle intelligent warning sensors systems and an automatic driving system, consists of a system which places in the lower area of the vehicle a signal detector and sensor system using reflective encoded elements, strips or bands arranged on the road surface or underground in the same. The signals received when are transverse or inclined are applied to a microprocessor, or directly to a visual warning or to an audio annunciator. The microprocessor decodes and compares the signals obtained with the vehicle speed, calculating and providing audible and visual warning signals. Additionally the system can provide lateral displacement signals with reference to central longitudinal lines, bands or strips, lateral or close to said side area, captured by the sensors in the bottom of the vehicle, and/or place a video camera or a laser radar in the upper front of the vehicle or in the lower region thereof, directed to one or more central longitudinal lines or stripes of each lane, generating, in addition to the warning signals, other of control, which are applied to an actuator that drive the fuel flow valve, which controls the engine gas or power and to the servomotor that drives and corrects the direction of the vehicle, the microprocessor compares each successive images captured by the camera, determining as a result, the shift to one or other side, correcting consequently and instantly the direction of the vehicle.

The microprocessor additionally receives signals from GPS, accelerometer, braking, acceleration, wheel speed of the vehicle, alert conditions, the front and rear laser radar (distance from the front and rear vehicles), and is fed back the position wheel follower signal, these signals are processed by the microprocessor, that sends a signal to the steering servo which drive an electric motor and through a rpm reducer corrects the direction of the vehicle, rotates the hand wheel and feeds back the follower negative signal to the microprocessor compensating the deviation signal generated with the different images captured, correcting the direction of the vehicle to match that indicated by the line, a second signal is applied to an amplifier which feeds the electric motor that drives the fuel control valve, a third signal visually warns of failures, and a fourth signal is sent to an audio generator which is applied to a loudspeaker.

The sensor system may consist of: a) A metal detector, b) A laser light reflection system, c) A capacitive system, d) An electromagnetic system, e) An electrostatic system, f) An induction system, g) A mini radar system, h) A microwave system i) A photoelectric system and/or j) A video camera system. In all cases are used reflective elements or coded bands, consisting of bands, lines, strips, plates, meshes, wires, on the pavement or buried in its interior. Can be used metallic paint, consisting of paint with a metallic powder or grain, reflective paint or lack luster or roughness stripes on the pavement In the latter case, the rough zone acts of anti-reflective area of the light waves. The sensor system can be fixed or oscillating or swing, making a transverse scanning over longitudinal bands or stripes. In this case you only have a single transducer. In some cases, the transmitter and receiver form a single element.

Signaling reflective elements reflect optical, infra-red, microwave, electromagnetic waves, induction, electrostatic or radio magnetic signals. The metallic and paint bands, lines, strips, etc. may have different widths and can be positioned transversely, longitudinally and/or inclined with relation to the roadway. The longitudinal will be used preferably in the centre and on the sides and near the sides of the road, to warn the driver or to act on the vehicle steering. Those of paint can add metal powder or granules as aluminum, copper, bronze, magnetic or ferromagnetic materials, etc., and can use different colours. Can be used one or more reflection systems in the same band or in the same area, an example may be a painting band with metal sub-bands or of metallic paints. Also can be added to the central longitudinal lines segments coded with different colours, magnetic or metallic particles, etc. which report the need to inform of the need to reduce vehicle speed by curves or other reasons. Can be used a degraded paint line or strip, which has its central zone brighter or with more metal powder concentration and less brightness or concentration of metallic powder and decreasing towards the side edges. In the case of laser systems and due to its precision multiple signals can be used on the ground that provide large amounts of information.

Can be used as underground wires as electrically energized loops or coded with different currents, voltages and frequencies, whereupon signals can be modified electrically depending on the day, time, intensity or estimated traffic intensity.

Although less useful also can be used metal detectors of the VLF type, very low frequency, pulsed induction PI, or BFO or beat frequency detection.

Different systems detect when they have passed over two or more strips, plates etc. separated by different distances so encoded like a bar code, so that the microprocessor identifies and send the signal to a sound or voice generator and/or visual signal, informing we are approaching a restrictive zone. This is valid even for other caution areas such as curves, stops, schools, pedestrian crossings. Can indicate if you have priority or not at a crossroads, etc. Adding a colour code, signals can be enabled or disabled at certain times or epochs.

The sound produced can be very simple or it can be a voice generated by the microprocessor itself, by a microchip or by a generator of synthetic voices, which indicates not exceed a certain speed or other traffic signs, for example you can use: “No overtaking”, “Caution works”, “No acoustic signals”, “Children”, “Stray animals*,* Limit 120 km/h”, “Intersection without priority”, “Priority Crossing”, “Crossing without gatekeeper”, “Baden”, “Dangerous Curve”, “No Trucks”, “No right turn”, “Preferential step” “No loading and unloading” “End of . . . .”, etc. some of which are of difficult perception.

Notices on curves is useful so that the vehicle reduce speed in sufficient time before the curve is detected by the camera or laser radar. The signals can be modified as a function of time or event, being controlled remotely feeding underground electrical wires, useful in train crossing without gatekeepers. The signals can also be varied supported by the microprocessor clock, the system will ignore some signals depending on the time zone, festive day, eve party, etc. automatically and without having to physically modify the signals.

The automatic driving system simultaneously controls the steering and speed of the vehicle.

A flashing light on the back of the vehicle can warn the vehicles that follow.

The system can be made without limitation using different electronic circuits.

The device is very simple and can be applied to motorcycles, tricycles, etc.

The lines or stripes of metallic paint and the underground metallic wires, mesh or strips, both the longitudinal and the transverse or inclined are especially useful in snowy or icy roads, both when used as warning signs, as when they are used to control the steering such as an autopilot. Underground wires and mesh can be fed electrically, detecting the current flowing through them electro-statically or electromagnetically.

The metallic material used in the lines, stripes, wires, strips, mesh, etc. may be magnetic or non-magnetic.

The signal detectors or sensors can be attached externally to the underside of the car.

The signal detectors or sensors can be mobile, moving vertically supported by a spring and protected by wheels which protrude and prevent contact of the detector with the pavement.

A cleaning system of the mud and dirt using an oscillating brush and/or a water jet is applied to the photoelectric emitters and detectors, lasers, etc.

The separation between lines or stripes determines the type of warning.

The separation between two lines or stripes can determine the activation time of performance of light or audible warning when microprocessors are not used.

The system may inform the outputs of some roads, to avoid the case of driving in the opposite direction.

Lines can be of reflective paint and of a special colour, you need to determine, to avoid confusing or misleading.

A single line or band can carry several warnings using different colours.

For luminous warnings, can be used lights or LED of various colours, for example, amber, red, etc.

Can use several groups of lines, bands, cables etc., separated from each other therefore multiply their chances or number of messages.

Can be used groups of lines, bands, wires etc., encoded on both sides of the track, each group using their independent detector on both sides of the vehicle.

Lines or stripes of two widths can use a coded information similar to Morse, so that when driving the vehicle over the same, detects narrow lines as dots and the wide as dashes. When a single line is used, there are two possible notices a wide and a narrow. With two lines can give or encode four different notices. With three lines can give or encode eight different notices. Therefore, using simultaneously independent groups of one, two and three lines can be encoded fourteen notices, and using both sides of the roadway simultaneously with such lines can be obtained or encode 196 different signals or notices. All this can also be achieved by using each line with different colours or with a mixture of colours and metallic strips.

The ads can be displayed on a screen and also some lights until it exceeds the restricted area.

### BRIEF DESCRIPTION OF THE DRAWINGS

FIG. 1 shows a schematic partial view of a vehicle with a block diagram of the system of the invention.

FIGS. 2 through 5, 7 through 24 and 28 through 31 show diagrammatically and plan views of sections of road with lines or strips on them.

FIGS. 6, 25 and 40 show partial views of a block diagram of the system of the invention.

FIGS. 26 and 27 show variants of two warning circuits of the system of the invention.

### MORE DETAILED DESCRIPTION OF THE DRAWINGS

The invention, FIGS. 1 and 6, FIG. 1 shows a vehicle with a steering system with a microprocessor that receives images from the video camera or laser (24) placed in front or under the vehicle, which captures from the centre line or strip (2e) of the lane, with signals of GPS, accelerometer, braking, acceleration, wheel speed of the vehicle, warning conditions and laser radar beam (11) and rear (12), which report the distance from the front and rear vehicle respectively. It is also fed the signal of the follower (21) of the steering wheel position (22). These signals are processed by the microprocessor that sends a signal to the steering servo which drives the electric motor (20) that corrects the direction of the vehicle, including the steering wheel, and feeds back the negative signal to the microprocessor to compare it with the steering wheel position signal. Another signal is applied to the actuator that move the gas valve (23) of the accelerator, a visual signal of failure (17) and another to the audio generator (5) which in turn feeds the speaker (6). The latter emits warning signs of failures or important emergency actions to be performed. Audio signals may be generated in the microprocessor itself. No knobs or switches are shown on the system. Optionally a signal can be applied to the brakes, but as it is dangerous, it is more practical to reduce the speed. The signal from de camera can be replaced by the signals received at the bottom of the vehicle as shown in FIG. 40. The sensor or transducer (3) of the transverse lines or strips (2) can be used as an independent or supplementary system of guidance. FIG. 6 shows a vehicle (10) on the road surface (1) of a lane, reflective signalize elements (2), the sensor or transducer electromagnetic, radio magnetic, laser, photoelectric, capacitive, microwave, etc., (3a) attached to the bottom of the vehicle, which by detecting the metal band sends the signal to the microprocessor (4) that processes it, illuminating if appropriate led (7) inside the vehicle and (7a) in the rear area to warn drivers that follow. Another signal is applied to the sound generator (5) which in turn sends it to the speaker or buzzer (6).

FIG. 2 shows the road surface of a lane (1) with a continuous longitudinal line or strip of paint in its centre, with cross signals (2q) that warn of approximation of a curve, caution zone, dangerous zone, of restricted speed, etc. These lines can be dashed, even of different colours and fluorescent paints. The section of broken line or dashed line (2p) can also indicate the approach to a curve, caution zone, danger, etc.

FIG. 3 shows the road surface of a lane (1) with two longitudinal stripes or lines of paint in the middle of it (2f).

FIG. 4 shows the pavement of a lane (1) with a line or longitudinal stripe or lines of paint in the middle of it (2k). This line carries the metallic or degraded metallic paint from the centre thereof to the sides. The microprocessor compares each of the images received by the camera with the previous image and determines the correction that must be applied to the vehicle steering.

FIG. 5 shows the pavement of a lane (1) with three longitudinal lines in the centre, a centre line and two narrower lines or paint stripes on the sides of these (2m). These lines may be of different colours.

FIG. 7 shows the pavement of a lane (1) with two transverse lines or stripes (2) whose separation is encoded according to the separation between the two. These lines can also provide the duration or activation time of warning signals when the microprocessor is not used.

FIGS. 8 and 9 show one-way systems (1) having a transverse centre line encoded by two different widths or thicknesses of the same, equivalent to the dot and dash in the Morse code, when crossing them transversely or at right angles.

FIGS. 10 through 13 show one-way systems (1) with two transverse lines or stripes (2) encoded (four possibilities) by a system of two different widths, equivalent to the dot and dash in the Morse code.

FIGS. 14 to 21 show one-way systems (1) with three transverse lines or stripes (2) encoded (eight possibilities) by a system of two different widths, equivalent to the dot and dash in the Morse code.

FIGS. 22 and 23 show two examples of one-way systems (1) with groups of one or two transverse lines or strips (2) encoded on both sides of the lane, detected by two sensors, one on each side. Each group can provide up to 6 ads, the two groups on one side can provided up to 36 different ads, which in combination with the other side or warnings are 1296 possibilities or warnings. Encoding with different colours can increase the number of warnings. These sensors can be used when slanting lines are utilized.

FIG. 24 shows the road surface of a lane (1) with three transverse lines or stripes (2) whose spacing determines the encoding of the different signals.

It shows an encoding system with lines, stripes, etc., but many more can be performed without limitation, which is impossible to represent in this text.

FIG. 25 shows the pavement of a lane (1), the reflective display element (2) which reflects the wave sent by the transmitter or fixed focus (13), which may be a laser emitter, light, etc., the optical or laser sensor (3a) capture it and sends it to the microprocessor (4) where is processed with the vehicle speed signal (10), the distance to the front vehicle (11) and to the rear (12), with a laser radar or similar systems, illuminating the light emitting diode (7) and the sound generator (5) which in turn drives the speaker or buzzer (6). Additionally sends a deviation signal from a longitudinal line, band or strip located in or on the pavement in the middle or inner side of the lane, feeding the servo (8) whose motor rotates in the correct direction the gears (9), correcting the direction of the vehicle to match that indicated by the line. The position signal is fed back to the microprocessor to compare with the steering wheel position, it is shown in dashed lines. The system sends multiple correction signals whenever the vehicle separates from the line, band or route.

FIG. 26 shows a simple system of photosensitive type, which uses a light emitter (14), whose light is incident on the reflective surface (2) incident on the photo diode (14a) which is current conducting at that time and active light emitting diode (7) and/or buzzer or speaker (6). The activation time should be greater than the movement of the reflective band and therefore for not wearing a microprocessor, you must add a time delay circuit during the performance of the diode light and buzzer.

FIG. 27 shows a simple system of photosensitive type, which uses a light emitter (14), whose light is incident on the reflective surface (2) incident on the photo transistor (14a) which is current conducting at that time and active light emitting diode (7) and/or buzzer or speaker (6). The activation time should be greater than the movement of the reflective band and therefore for not wearing a microprocessor, you must add a time delay circuit during the performance of the diode light and buzzer.

FIG. 28 shows the pavement of the one way road (1) with three rows of reflective metal nails or tacks (2b).

FIG. 29 shows the pavement of the one way road (1) with inclined reflective metal bands (2c), these can also report the start or end of a restriction zone. Requires two side detection systems.

FIG. 30 shows the pavement of the one way road (1) with a reflective longitudinal line or strip in its centre (2e). The bands are preferably of paint or metallic paint and may be formed laterally of two or three colours, thus may be sufficient a single sensor or transducer. In the latter case when the sensor detects a single colour gives a command to turn the vehicle to the side of the opposite colour. What is performed at high speed.

FIG. 31 shows the pavement of the two-way road (1) with longitudinal metallic reflective lines or strips on the sides of the same (2g). The bands are preferably of paint or metallic paint. In this case lateral sensors are used on the boundary of the pathway that prevent lateral movement of the vehicle.

FIG. 32 shows a section of road surface (1) with the line, band or layer of photo-reflective paint (2a). This can be placed transversely or longitudinally, in the latter case will act as a reference for steering control of the vehicle. Can be use metallic paint.

FIG. 33 shows a stretch of road surface (1) with the reflective metal lines or bands (2).

FIG. 34 shows a stretch of road surface (1) with the reflective metal lines or bands (2h) underground.

FIG. 35 shows a stretch of road surface (1) with underground cables (2j) as reflective elements.

FIG. 36 shows a stretch of road surface (1) to the underground cable (2j), this can be positioned transversely or longitudinally, the latter as a reference to control the vehicle steering.

FIG. 37 shows a section of road surface (1) with a row of reflectant metal head nails or tacks (2b).

FIG. 38 shows a stretch of road surface (1) with a line or band or pavement mixed with powder grains of a metallic material (2k).

FIG. 39 shows a stretch of road surface (1) with a line or band of dull or rough pavement (2m).

FIG. 40 shows the three sensors (3, 3a,3b) receiving the signals reflected from the reflective line or band (2) or its adjacent area, emitted by the light focus (13) which is fixed and can be a LED. These signals together with the vehicle wheel speed (10), the front laser radar beam (11) and the rear one (12) are processed in the guided or automatic driving microprocessor and sent to the steering servo which drives the motor (20) that corrects the vehicle steering, turn the wheel (22) and feed back from the translator (21) a negative signal to the microprocessor to compensate the signal sent from the steering wheel.

1. An automatic driving system for vehicles, of the type used in vehicle warning systems intelligent sensors and automatic driving, which consists of a system that places a video camera or laser radar in the upper front or bottom of the vehicle, which is directed to one or more central longitudinal lines or stripes of each track, and/or captures these deviations on underground lines or elements or not, by means of sensors in the lower area of the vehicle, generating further warning signals, other of control, which are applied to an actuator that actuates the fuel flow valve, which controls the gas or engine power and the servo that drives and corrects the direction of the vehicle, the microprocessor compares each other successive images captured by the camera, determining the effect of displacing one side or the other consistently and instantaneously correcting the direction of the vehicle.

2. System according to claim 1, wherein said microprocessor additionally receives signals from GPS, accelerometers, braking, acceleration, vehicle wheel speed, alert conditions, the front and rear laser radar, and is fed the signal from the follower wheel position, these signals are processed by the microprocessor which sends a signal to the steering servo that drives an electric motor through a rpm reducer corrects the direction of the vehicle, rotates the wheel and feeds back the negative signal from the follower to the microprocessor to compensate for the deviation signal generated with the different images captured, correcting the direction of the vehicle to match the indicated by the line or lines, a second signal is applied to an amplifier which feeds the electric motor that drives the fuel shut-off valve, a third signal visually warns the faults and fourth signal is sent to an audio generator that is applied to a speaker.

3. (canceled)

4. System according to claim 1, wherein the central line or strip is metallic.

5. System according to claim 1, wherein the centreline carries the paint or metallic paint, degraded from the centre thereof to the sides.

6. (canceled)

7. System according to claim 1, wherein are used one or more continuous central longitudinal lines, making them discontinuous to give warnings, lines of the same or different colours.

8. System according to claim 1, wherein are used central longitudinal lines, coded sections with different colours, magnetic or metal particles, for reporting the need to reduce vehicle speed by curves or other reasons.

9. System according to claim 1, wherein are used one or more continuous central longitudinal lines with transverse lines for announcements, the lines with the same or different colours.

10. System according to claim 1, wherein the sensors are placed on the two sides of the bottom of the vehicle and capture the deviations from the sidelines of the lane.

11. System according to claim 1, wherein are added to the microprocessor signals of buried cables, mesh or metal strips, or lines, bands or stripes of paint, or metallic paint transverse or inclined detected in the lower area of the vehicle, which are signals that warns of hazard warning, caution, reduce speed, curves and the like.

12. System according to claim 1, wherein are added to the microprocessor signals of buried wires, mesh or metal strips fed electrically and detected electro-statically or electromagnetically on driving over them.

13. A warning system of areas of reduced speed for vehicles, which consists of a system which places in the lower area of the vehicle a signal detector and sensor system using reflective encoded elements, strips or bands arranged on the road surface or underground in the same, the signals received when are transverse or inclined are applied to a microprocessor, or directly to a visual warning or to an audio annunciator, the microprocessor decodes and compares the signals obtained with the vehicle speed, calculating and providing audible and visual warning signals.

14. (canceled)

15. System according to claim 13, wherein the signal detectors or sensors are moveable, moving vertically supported by a spring, protected by protruding wheels and avoid contact the sensor with the ground.

16. System according to claim 13, wherein are added a cleaning mud and dirt system to the emitters and detectors, using a squeegee and/or a water jet.

17. System according to claim 13, wherein the spacing between lines or strips determines the type of notification.

18. (canceled)

19. System according to claim 13, wherein warning or LED lights are used in various colours, and messages are displayed on a screen and also some lights until it exceeds the restricted area.

20. System according to claim 13, wherein are used coded stripes and lines with different widths.

21. (canceled)

22. (canceled)

23. System according to claim 13, wherein to the paint is added powdered or granulated metals like aluminum, copper, bronze, magnetic or ferromagnetic material.

24. System according to claim 13, wherein the system supported by the microprocessor clock, automatically ignore some signals depending on the time zone, holiday or eve.

25. System according to claim 13, wherein the wires, mesh or metal strips are fed buried electrically detected electro statically or electromagnetically to circulate over them.

26. System according to claims 1 and 13, wherein the sensor system used is: a) a metal detector, b) a system of laser light reflection, c) capacitive system, d) an electromagnetic system, e) an electrostatic system, f) an induction system, g) a mini radar system, h) a microwave system, i) a photoelectric system and/or j) a video camera system.
